(19) United States
(12) Patent Application Publication
(10) Pub. No.: US 2002/0174436 A1
(43) Pub. Date: Nov. 21, 2002

(54) System and method for providing on demand responses to consumer impulses produced by a demand stimulus

(76) Inventors: George Wu, Oakland, CA (US); Steven Chan, San Francisco, CA (US); Ronald Tamura, Fremont, CA (US); Elizabeth Shoemaker, Fostser City, CA (US); Tze-Yee Szeto, Santa Cruz, CA (US)

Correspondence Address: DONALD L. BEESON, ONE KAISER PLAZA, SUITE 2360, OAKLAND, CA, 94612, US

(21) Appl. No.: 10/025,849

(22) Filed: Dec. 17, 2001

Related U.S. Application Data
(60) Provisional application No. 60/255,800, filed on Dec. 15, 2000.

(51) Int. Cl. H04N 7/173

(52) U.S. Cl. 725/87; 725/101

(57) ABSTRACT

A system for providing on demand responses to consumer impulses produced by a demand stimulus includes a computer processing system and content databases accessible by the computer-processing system having stored stimulus responses corresponding to a plurality of consumer demand stimuli in at least two categories of demand stimuli. A real-time inquiry response system associated with the computer processing system receives inquiries provided by a consumer and identifies the content category with which the consumer inquiry is associated. The computer processing system correlates consumer inquiries received by the real-time inquiry response system with stimulus responses stored in the content database based on the content category identified by the inquiry response system, so that the real-time consumer response system can return to the consumer, in real time, a stored stimulus response which correlates to the consumer inquiry. Categories of demand stimuli can include broadcast and non-broadcast information, and can include a variety of information categories or sub-categories such as music, advertisements, and scheduled events in respect to which a consumer may desire information or make a purchase.

### CROSS-REFERENCE TO RELATED APPLICATIONS

Applicants claim the benefit of provisional application No. 60/255,800, filed Dec. 15, 2000.

### BACKGROUND OF THE INVENTION

The present invention generally relates to the distribution and acquisition of consumer information necessary to complete the consumer purchase cycle from stimulation of consumer demand to the purchase of a product or service. The invention more particularly relates to providing a facility for responding to consumer inquiries stimulated by a particular demand stimulus and for providing on-demand information regarding a product or service for facilitating the purchase process. The invention still further relates to the desire to provide consumer inquiry-based data to providers of goods and services so as to provide useful feedback or information to the providers regarding their goods and services.

Consumer demand for products and services can be stimulated by a wide variety of demand stimuli reaching the consumer through a wide variety of stimulus sources or media. Media through which consumer demand can be generated include TV and radio broadcasts, billboard advertising, print ads such as ads in newspapers, transit ads, magazines and promotional flyers, and electronic ads transmitted over a wide area network or the Internet. The demand stimulated through such a broad spectrum of media can involve a limitless array of products and services of which the following provide but a few examples: a song played on the radio may stimulate a demand to purchase the song by consumers listening to the radio station on which the song is played. A billboard ad for a product or service may stimulate a demand for the product or service by consumers who see the ad while traveling by the billboard. A TV program may stimulate a demand for a transcript of the program or other follow-up information such as film episodes. A movie schedule printed in a newspaper may stimulate a consumer's desire to see a particular movie listed in the schedule. All of the foregoing examples are examples of external stimuli through which a demand for a product or a service may arise when the external stimulus (hearing a broadcast, seeing an ad) is encountered. Demand stimuli can also be internal, for example, where a consumer desires to see a movie or concert, or where the consumer desires to read a book by a particular author, or an internally generated desire arises for a particular product or service. (An internal desire might also be stimulated by a referral or recommendation for a song, movie, etc., from someone else.) In the case of all such demand stimuli, whether external or internal, the consumer normally needs further information and/or incentives to act on the demand which has been stimulated by the initial media exposure. For example, the consumer may need the title and artist of a song heard on the radio and further secondary information such as pricing information and locations where recordings of the song can be purchased. Or in the case of an advertisement, whether broadcast, in print, or on a billboard, transit vehicle or a building, or elsewhere, the consumer may desire to know more information about the product including an expanded product description, product warranty information, conveniently located vendors for the product, pricing, and available discounts or other sales incentives. Or the consumer may want further information on a movie or theater such as current movie schedules, reviews, and ticket information.

Providers of goods and services, of course, desire to maximize the number of times the purchase cycle is successfully completed after a demand stimulus is first encountered by a consumer. A frequent barrier to the completion of the purchase cycle is the consumer's inability to act on the demand stimulus when it is encountered. For example, when the consumer sees a billboard advertisement which stimulates an interest in a product or service, he or she may forget about the advertisement or the product name, or supplier, within a relatively short period of time, thereby preventing any follow up to the stimulated demand. Similarly, a consumer may hear a song broadcast on the radio which he or she desires to purchase, without the ability to identify the song when it is fresh in the consumer's mind. There are many other examples of where the inability to access timely information acts as a barrier to completing the purchase cycle, including barriers to acting on internally generated demand stimuli as well as external demand stimuli. Examples include temporally limited accessibility to movie or concert schedules, or temporally limited accessibility to product or supplier information for products that a consumer desires to purchase. The limited accessibility may be temporal due to the inaccessibility of a portal through which information can be obtained by the consumer. Whatever the reasons for the delays in information or data access, such delays often result in a dissipation of the demand, and consequently a failure to complete the purchase cycle.

Heretofore, a number of on-demand sources of information have been provided for facilitating the purchase of products and services. For example, U.S. Pat. No. 5,661,787 issued to Michael Pocock discloses a system for on-demand remote access to a self-generating audio recording, storage and retrieval system, wherein a purchaser who hears a song broadcast over the radio is able to identify the song and artist by calling an 800 telephone number over a touch-tone phone and entering a broadcast identifier which is correlated to a program schedule stored on a central computer. The computer responds to the caller with a voice description of the song title and artist. Numerous Internet-based services also exist for providing on-demand information regarding products and services and for ordering products and services over the Internet.

There are a number of difficulties with existing approaches to providing on-demand information in response to consumer inquiries. First, existing approaches are generally limited to vertical systems which provide responses to consumer inquiries from a single source or medium. For example, the Pocock patent discloses to provide on-demand responses to inquiries stimulated by broadcast music, but does not at the same time provide a facility for receiving inquiries stimulated by other media, such as print advertising, billboard advertising, and movie schedules. Second, existing approaches to on-demand information retrieval are platform-specific or platform-limited, such as retrieval of information through product and service provider web sites. Such limitations to on-demand information regarding a product or service at the key point of interest of the consumer increases the probability that the consumer will not follow up after encountering the stimulus that created the demand.

Therefore, a need exists for a system and method for providing on-demand responses to consumer inquiries produced by a demand stimulus which maximizes consumer access and which provides on-demand real time responses to consumer inquiries produced by demand stimuli from a variety of media which may be encountered by a consumer, such as broadcast music, print advertisements, billboard advertisements, movie schedules, concert schedules, and the like. A further need exists for a system and method for providing on-demand responses to consumer inquiries produced by a demand stimulus, which permits data and information returned to the consumer to be customized and transformed based on the needs of the customers, and which permits consumer inquiry data to be collected, assembled and compiled for the benefit of and access by providers of goods and services.

### SUMMARY OF THE INVENTION

It is an object of the present invention to provide a system for providing on-demand responses to consumer impulses produced by a demand stimulus encountered in a variety of media (broadcast, print advertising, etc.). In accordance with the invention, on-demand responses to consumer inquiries are provided in real time at the peak point of interest of the consumer.

It is a further object of the invention to provide a system and method for providing on-demand responses to consumer impulses produced by demand stimuli which supports and interfaces with multiple platforms, so that the consumer can interact with the system and retrieve information in the way most convenient or appealing to the consumer.

It is a further object of the invention to provide a system and method for providing on-demand responses to consumer impulses produced by a demand stimulus which permits consumer inquiry data to be collected, assembled and compiled in a useful fashion for access by providers of goods and services who stimulated the consumer's interest.

Briefly, the system of the invention includes a computer processing system and content databases accessible by the computer-processing system having stored stimulus responses corresponding to a plurality of consumer demand stimuli in at least two categories of demand stimuli. A real-time inquiry response system associated with the computer processing system acts to receive inquiries provided by a consumer and for identifying the content category with which the consumer inquiry is associated. The computer processing system has means for correlating consumer inquiries received by the real-time inquiry response system with stimulus responses stored in the content database, based on the content category identified by the inquiry response system, so that the real-time consumer response system can return to the consumer, in real time, a stored stimulus response which correlates to the consumer inquiry.

In one aspect of the invention the content categories of demand stimuli include external demand stimuli and internal demand stimuli wherein stored stimulus responses in the stimulus content database include responses to both types of stimuli. In a further aspect of the invention, the stored stimulus responses are comprised of stored stimulus responses to broadcast demand stimuli which can include audio, video or text clips of the broadcast and/or further information regarding the broadcast. The broadcast demand stimuli can be broken down into separate categories, such as broadcast music and broadcast advertisements, wherein the stored stimulus responses for the broadcast music would include further information regarding the music and the stored stimulus responses for the broadcast advertisements would include further information regarding the subject of the advertisements. Other categories of demand stimuli can, for example, include print advertisements and billboard advertisements.

In still a further aspect of the invention, the content database can include predefined key words or other keys supplied by providers of goods and services or by the system operator. When the consumer, by a voice, text or other input, transmits key words (or other defined keys) to the real-time inquiry response system, the means for correlating consumer inquiries with stimulus responses stored in the consumer stimulus content database will use the predefined keys to associate the consumer inquiry with a stored stimulus response. Thus, a consumer inquiry which includes a predefined key will return a stored stimulus response associated with the key.

In other aspects of the invention, the stored consumer inquiry response to consumer inquiries involving the advertisement of a product or service may include one or a combination of the following: information regarding the subject of the advertisement which stimulated the consumer demand, contact information for the advertiser which allows the consumer to contact the advertiser directly to learn more about the advertised product or service, an option to request a direct transfer of the consumer to a representative of the advertiser (a “hot transfer”), and the return of an indicia of a redeemable discount for an advertised product or service, such as an electronic or physical coupon.

In still a further aspect of the invention, a system is provided wherein a category of internal demand stimuli involve a consumer's desire to attend an event, and the stored stimulus responses to a consumer inquiry stimulated by such desire include further information regarding the event. Such events can include movies, concerts, plays, nightclub acts, lectures, and special events, and further information on the events can, for example, include one or a combination of event descriptions, event schedules, and ticket purchase information for the event. The stored stimulus response can also include contact information for a provider of the event which allows the consumer to contact or be transferred to the event provider directly to learn more about the event or to be transferred to an order processing system for purchasing tickets to the event.

In yet a further aspect of the invention, the real-time inquiry response system of the invention can support more than one, and preferably multiple platforms acting as a consumer inquiry interface to the system, and through which consumer inquiries can be made. The inquiry response system preferably will support multiple platforms selected from a group of platforms consisting of land line telephones, cell phones, data communication devices, and personal computers.

### DESCRIPTION OF THE DRAWINGS

FIG. 1 is a block diagram showing an overview of a system in accordance with the invention.

FIG. 2 is a block diagram showing in greater detail the computer processing system and real-time inquiry response system of the system of the invention depicted in FIG. 1.

FIG. 3 is a graphically depiction of the content of the consumer inquiry databases of the system shown in FIG. 1, and the means for updating the databases.

FIG. 4 is a block diagram showing in greater detail the broadcast identification system show in FIG. 3.

FIG. 5 is a flow chart showing a method of providing on demand responses to consumer impulses produced by a demand stimulus practiced in accordance with the invention.

FIG. 6 is a flow chart showing a process of registering users of the system of the invention through consumer service representatives or IVR prompts.

FIG. 7 is a flow chart illustrating the inquiry response follow-up activity including sending follow-up e-mail messages and/or sales incentives to a consumer using the system and giving the consumer an opportunity to purchase a product or service including a possible transfer to a supplier representative.

FIG. 7A is a flow chart illustrating steps for archiving demand inquiry responses and sending personalized messages to a user making an inquiry.

FIG. 8 is a block diagram illustrating conceptually how the system of the invention can by accessed by the consumer through multiple platforms.

### DETAILED DESCRIPTION OF THE ILLUSTRATED EMBODIMENT

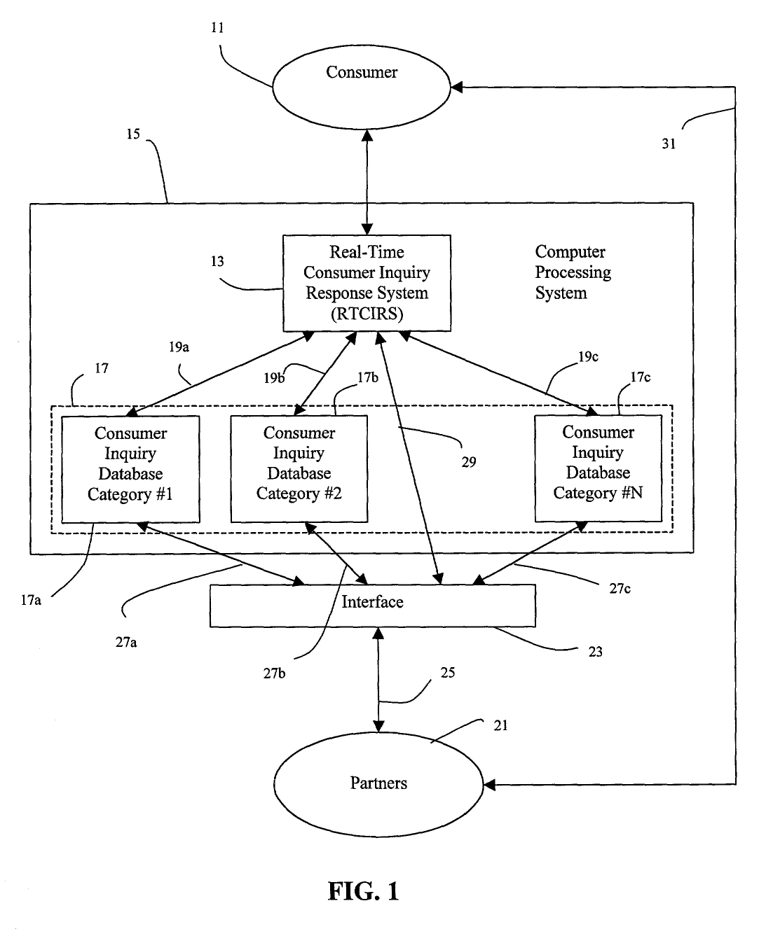

Referring now to the drawings, FIG. 1 provides a conceptual overview of the system of the invention wherein a consumer 11 interactively communicates with a real time inquiry response system (RTIRS) 13 of a computer processing system 15 having a content database 17 containing consumer inquiry information data for at least two and suitably multiple categories of inquiries as represented by blocks 17a, 17b and 17c.

The contents of the database 17 are categorized in terms of the different types of media and demand stimuli which stimulate a consumer inquiry. For example, category #1 as represented by block 17a might contain consumer inquiry information and data pertaining to broadcast music wherein the database contains a schedule or “playlist” of broadcast songs by identified broadcasters and stored responses that are correlated to the broadcaster's playlist. When an inquiry is received from a consumer 11 by the real time inquiry response system 13 which is related to a broadcast song heard by the consumer on the radio or TV, the RTIRS causes the system to respond to the consumer by accessing data, including stored demand stimulus responses, from the category #1 portion of the consumer inquiry database as represented by data flow arrow 19a. A second category of stored information, as represented by block 17b, might, for example, include data and information pertaining to advertised products wherein an inquiry from consumer 11 regarding an advertised product or service seen or heard by the consumer can be processed by accessing information and data in the category #2 block of the database as represented by data flow arrow 19b. Still a further example of a category of information and data, represented by block 17c and denoted category “#N,” may be information and data related to movies which a consumer may desire to see, including movie schedules of participating theaters, movie reviews, ticket price information, and/or video tape availability information. Thus, a consumer inquiry pertaining to a movie would be handled by the real time inquiry response system 13 by accessing the category “#N” block in the consumer inquiry database as represented by data flow arrow 19c. Generally, the database categories are selected and added to the system based on the types of data and data organization and structure peculiar to a given category.

It is noted that each category of information and data in database 17 can be divided into subcategories depending on how stored information and data are organized and accessed by the RTIRS. An example of main database categories would be information and data pertaining to demand stimuli which can be associated with an identifiable source, such as a radio station, TV station, print publication, and possibly even the location of a billboard, and data and information pertaining to demand stimuli which have no identifiable source, such as an internally stimulated desire to see a movie or a concert, or to obtain more information regarding a particular product or service. The subcategories of information within these main categories would in turn pertain to the subject of the inquiry such as a song, advertised product or service, movies and concerts.

FIG. 1 also pictorially illustrates how suppliers of goods and services, called “information providers,” interact with the system of the invention and with consumers who use the system. Generally, information providers, which are represented by block 21, will have access to the computer processing system 15 through an interface 23 which permits communication between different types of data terminal equipment (DTE's). Particularly, data flow links are provided between the information providers and the system's consumer inquiry database (as represented by data flow arrows 25 and 27a, 27b, 27c), and between the information providers and the real time inquiry response system 13 as represented by arrow 29. Information providers are provided with direct access to the consumer inquiry database for purposes of supplying information and data, including demand stimulus responses, to the database and for the purpose of retrieving collected inquiry data related to the information providers' product or service. More specifically, each information provider will have access to the database category to which its product or service pertains. For example, an information provider who is a radio station may supply a broadcast schedule in the form of a playlist, and perhaps further information regarding songs on the playlist, to the category #1 segment of the consumer inquiry database. At the same time, useful inquiry data may be collected on the database which can be retrieved by radio stations, such as the number of requests received by the real time inquiry response system over a defined period of time for the stored songs. Similarly, an advertiser of a product or service may supply ad related information and data to the category #2 database (block 17b) as well as desired stored demand stimulus responses to the ads, such as a description of the product, product promotions, and retail locations where the product can be purchased. At the same time, collected inquiry data related to the product or service, such as the number of requests for a product or system received by the real time inquiry response system within a specified period of time, can be retrieved by the advertiser.

In yet another example, information providers who are movie theaters may supply the consumer inquiry database, in this case category #N, with movie schedules, ticket prices, and other useful information pertaining to movies selected. It is contemplated that more than one information provider could supply data and information to a particular database category which can be aggregated into a predefined demand stimulus response. For example, theaters could supply movie schedules and ticket prices while newspapers could supply movie reviews related to the movies shown at the theaters. As hereinafter described, it is also contemplated that in certain categories, the stimulus content and responses may be inputted to the database by someone other than the information providers, that is, by someone other than the providers of the goods and services.

It is further noted that data link 29 between the real time inquiry response system and the information providers is shown to indicate that communications can occur directly between the RTIRS and the information providers which may or may not involve retrieval of data from the database 17, such as a facility whereby the real time inquiry response system passes inquiry requests from consumers directly to information providers in addition to or instead of returning a stored stimulus response to the inquiry from the inquiry database. The information providers may also want to communicate directly with the RTIRS to indicate content for the databases is available from the information providers, such as new advertisement content.

Finally, FIG. 1 shows a direct communication link 31 between the consumers and the information providers to permit the consumers and the information providers to talk directly to each other once placed into contact with each other by the real time inquiry response system. This would occur, for example, where the stored inquiry response returned to the consumer by the RTIRS includes direct contact information for a supplier of a product or service, e.g., an 800 telephone number or supplier URL, or where the information providers retrieve contact information for the consumer from the consumer inquiry database or are sent this information directly via data link 29 by the action of the RTIRS.

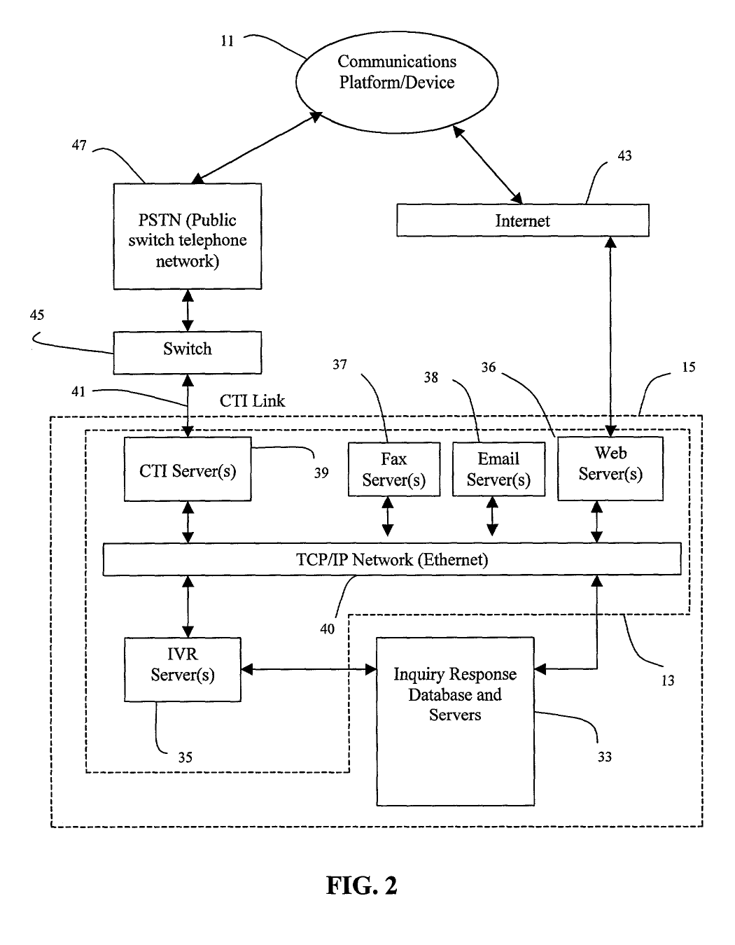

As shown in the FIG. 2 embodiment, the RTIRS 13 includes an interactive voice response system (IVR) in the form of one or more IVR servers 35 which permit interactive voice communications with information consumers who make telephone inquiries to the system. The RTIRS also includes one or more web servers 36 to permit interactive web communications between the RTIRS and the information consumer, one or more fax servers 37 for fax communications, e-mail servers 38 for sending inquiry responses via e-mail, and computer telephony integration (CTI) servers 39. All servers are connected through a TCP/IP network 40. A CTI link 41 is provided to a switch 45 for the public switch telephone network (PSTN) 47 through which an information consumer places a call by means of a land wired or mobile telephone.

The IVR servers 35 provide the voice-to-text and text-to-voice conversions for consumer inquiries coming in through a telephone network while the CTI's servers direct consumer inquiry traffic to available ports for the IVR's servers. For example, IVR's servers can serve up stored audio clips in response to a consumer inquiry related to a song or advertisement. Such audio clips can be a segment of a song and/or a voice description of a song title or artist, or an audio clip and/or description of an advertisement, or a listing of or directions to the closest retail outlets for an advertised product or service to which the inquiry pertains.

Interaction between the consumer 11 and the real time inquiry response system 13 can also be accomplished through the Internet 43 by means of the system's web servers 39 which permits inquiries to be made by the consumer through a personal computer or wireless information devices, such as WAP telephones or personal digital assistance (PDA's).

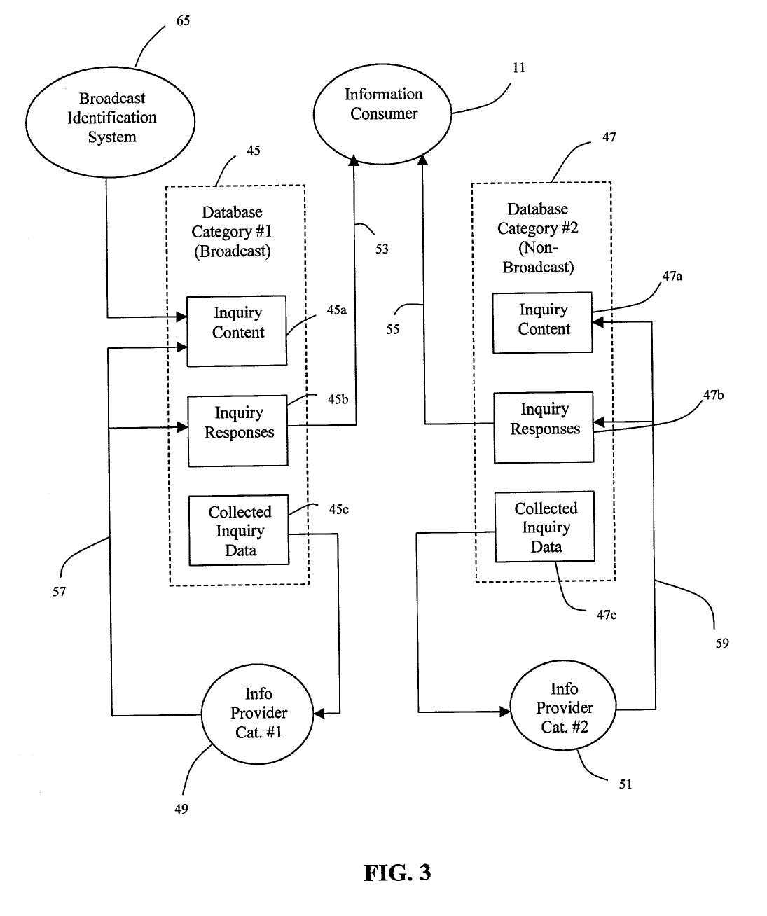

FIG. 3 illustrates a general structure for the content of the consumer inquiry database for each category of information and data contained in the database. For illustrative purposes, FIG. 3 shows two categories of data and information, the first of which (category #1) is from a broadcast source such as broadcast music, and the other of which (category #2) relates to a non-broadcast source such as print and billboard advertisements. FIG. 3 also generally illustrates links for updating the database and retrieving information from the database by the information providers for the system.

The two database categories illustrated in FIG. 3, denoted by the numerals 45 and 47, each contain a demand stimulus content 45a, 47a, demand stimulus responses 45b, 47b, and collected inquiry data 45c, 47c. The demand stimulus content includes the demand stimulus data and information about which a consumer may inquire. For example, in database category #1 for demand stimuli produced through a broadcast media, the demand stimulus content 45a may include the broadcast schedules or playlists for identified broadcasters which identify music played by date and time. The demand stimulus responses 45b for this database category might include audio clips of the music correlated to the playlist stored as part of the demand stimulus content 45a, as well as voice and/or text messages identifying the music played by title and artist, or it may include video clips or graphics conveying information about the music. Other stored demand stimulus responses may include text messages that can be delivered to a web page or e-mail box for the consumer or to some other consumer text based communication device. Demand stimulus responses might further include coupons, including electronic or physical coupons sent to the consumer as hereinafter described.

Examples of the demand stimulus content 47a for the category #2 database for non-broadcast demand stimuli would include advertiser names, product names, pricing information, contact information, promotional information, and locations of retailers or e-tailers of products or services. Stored demand stimulus responses 47b for this category might include a voice message correlated to an advertiser's name and/or product name which provides information regarding the product or service, for example its availability and pricing, and stored text messages, video clips and/or graphics which can be delivered to the consumer 11 via a communication network. The stored demand stimulus responses 47b of category #2 might as well include a discount coupon for a product or service delivered to the consumer. This might, for example, include sending a digital coupon to the user's wireless information device, such as a WAP telephone or PDA, which the consumer can take to a participating retailer of product or service for redemption.

The collected inquiry data 45c, 47c of database categories #1 and #2 include all information and data relating to a consumer inquiry which is tracked, organized and compiled by the system. This would include user specific information, such as types of products and services purchased by a registered user, as well as product/service specific information such as the number of inquiries received for particular songs, or the number of inquiries received about particular products or in response to particular advertisements. By tracking inquiries regarding advertisements, advertising providers to the system can utilize the collected inquiry data to judge the effectiveness of particular ads in specific media, for example, the effectiveness of an ad played on a specific radio station.

FIG. 3 also shows access to the databases 45, 47 by information providers 49, 51, as well as delivery of demand stimulus responses to the consumers 11, as denoted by data flow arrows 53, 55. It is seen that the information providers for each of the categories #1 and #2 supply information and data to the demand stimulus content and the demand stimulus responses in the respective database categories, as denoted by data flow arrows 57, 59, and also have access to the collected inquiry data for retrieving such data as denoted by data flow arrows 61, 63. By having access to the collected inquiry data, the information providers can monitor inquiries regarding their respective goods and services on demand or on a defined schedule.

It is noted that demand stimulus content 45a in the broadcast database category #1 can also be supplied from a broadcast identification system 65 described below. It is further noted that the demand stimulus content and demand stimulus responses may also be inputted manually or can be imported from another database or other data sources. Also, demand stimulus responses can be generated from demand stimulus content such as a text to voice conversion of song titles, and artist names stored as part of the demand stimulus content.

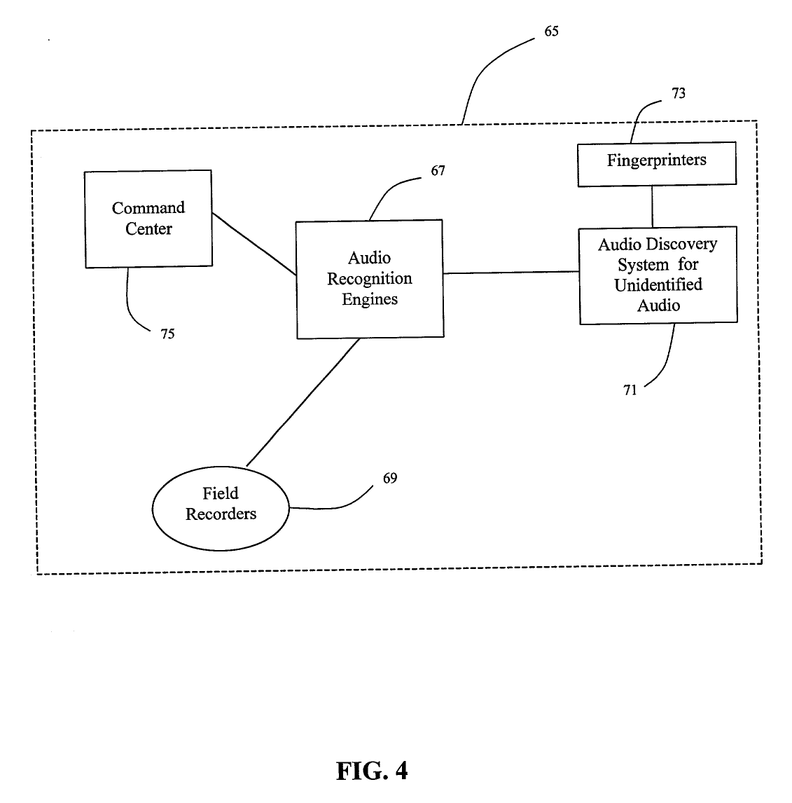

FIG. 4 illustrates a broadcast identification system by which stimulus content for the broadcast category database 45 shown in FIG. 3 can be obtained from the air waves through known broadcast signal identification systems and methods. Generally, the broadcast identification system 65 includes audio recognition engines 67 capable of identifying songs or other broadcast materials as they are being played by radio stations. The audio recognition engines identify songs received by field recorders 69 using a technique by which unique waveform characteristics or “fingerprints” of the songs are matched to the fingerprints of songs stored in a database of the audio recognition engines. Such a broadcast identification system and method is described U.S. Pat. No. 5,437,050, issued to Robert G. Lamb, et al., entitled Method and Apparatus for Recognizing Broadcast Information Using Multi-Frequency Magnitude Detection. By using such audio recognition techniques, playlists of tracked broadcasters can be built up and stored in the demand stimuli content portion of the database 45 shown in FIG. 3 without the need to obtain playlists from the broadcasters. Over time, the audio recognition engines will build up a library of broadcast songs to which future broadcasts can be matched. For broadcast songs which cannot be identified through the audio recognition engine's own library of songs, an audio discovery system is provided as represented by block 71. The audio discovery system provides unique fingerprints for a comprehensive library of songs which are entered in the library through fingerprinters 73. Block 75 generally represents a command center which controls the feeds from the various field recorders 69 to the audio recognition engines.

Once the broadcast identification system has identified a broadcast song, or other broadcast content, such as an ad, the song or ad is immediately added to the content of the consumer's inquiry database so that demand stimulus responses can include information on the most currently broadcast song or ad.

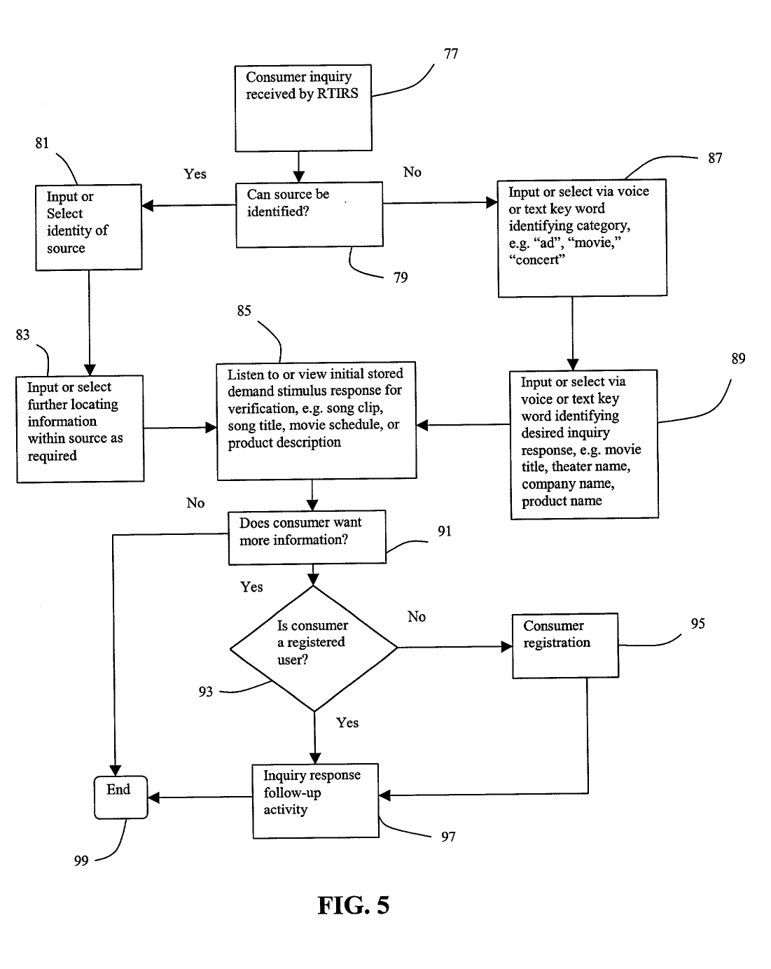

The flow charts in FIGS. 5, 6, 7 and 7A illustrate a method by which a consumer inquiry received by the RTIRS can be processed in real time for different categories of consumer inquiries. Referring to FIG. 5, when a consumer inquiry is received by the RTIRS, as represented by block 77, a determination is made by an interactive communication with the consumer whether the source of the demand stimulus can be identified (block 79). Again, an example of a source identification would be the identification of a radio station on which a song or ad were broadcast. Other possibilities might be the location of a billboard or a transit ad or an identifiable issue of a publication where an ad or other demand stimulus is seen. If a source of the demand stimulus can be identified, the consumer is prompted to input an identification of the source or to select from a menu of source selections (block 81). For example, a consumer can be prompted to enter the call letters of a radio station on which a song is heard, or the name and date (or approximate date) of a publication in which an ad is seen. As required, the consumer can then be prompted to input or select further locating information (block 83) such as the date and approximate time a song was heard, or the product name or advertiser name in the publication previously identified. With the information supplied by the consumer, the RTIRS returns an initial stored demand stimulus response to the consumer for verification of his choice as represented by block 85. If a consumer is using a telephone and communicating with the RTIRS by means of interactive voice response system (IVR), demand stimulus responses can be in the form of one or more audio clips, such as a song clip, or a voice response which states a song title, or a product description associated with the particular inquiry made. If the consumer is communicating with the RTIRS through a personal computer or wireless information device, then the demand response can be in the form of a retrievable message which can be displayed on a computer or device screen and/or as an audio message. Depending on how the consumer is accessing the system, the message could be displayed as text, graphics or video.

If the source of the demand stimulus cannot be identified, the consumer is prompted to input or select via voice or text, depending on how the consumer is communicating with the RTIRS, a key word or words identifying the category of information in which the consumer is interested (block 87). For example, consumer may be interested in an advertisement for which a source cannot be identified, or in a movie or a concert. To access these categories, the consumer can input or select via voice or text the word “ad,” “movie,” or “concert.” Upon selecting a category, the consumer is prompted to input via voice or text, again depending on how the consumer is communicating with the system, a key word identifying the desired inquiry response, such as a movie title, theater name, company name, or product name (block 89). It is possible that blocks 87 and 89 could be collapsed into a single step where the consumer simply inputs a key word such as movie title, theater name, company name, or product name which can be indexed to a corresponding demand stimulus response. It is also contemplated that advertisers could provide key words which they would incorporate into their advertising and input to the consumer inquiry database and which could be remembered by consumers for use in accessing inquiry responses associated with the ads. Once the key word or key words are entered in accordance with the steps represented by blocks 87 and 89, the consumer listens to or views an initial stored demand stimulus response (block 85) in the same manner as if the information were identified through a particular source.

After the consumer listens to or views the initial stored demand stimulus response as represented by block 85, the consumer can quit the system if no further information is desired. If the consumer wants to hear or see more (block 91), the RTIRS can take this opportunity to register the consumer as a registered user of the system (blocks 93, 95). (It is understood that a forced registration of the user, if provided, can occur at any point in the process, including immediately after the RTIRS receives an inquiry from the consumer, that is, between blocks 77 and 79.) After the consumer is registered, the system proceeds to generate inquiry response follow-up activity (block 97) as hereinafter described before quitting the system (block 99).

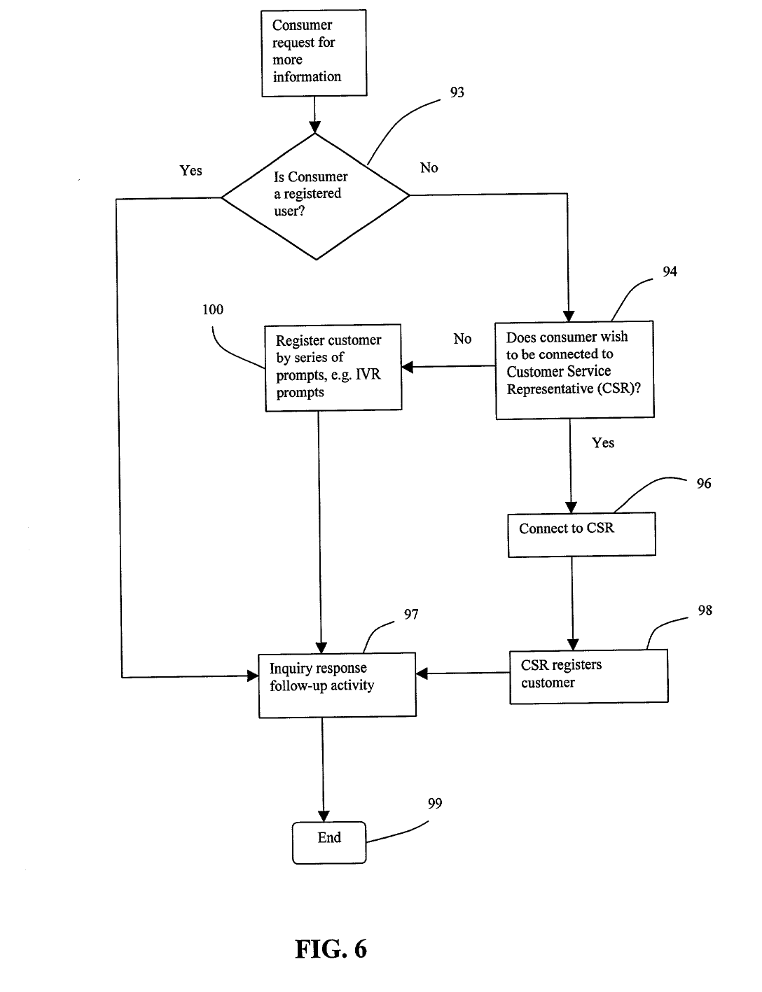

FIG. 6 illustrates the process by which the consumer can be registered as a registered user of the system as represented by block 95 in FIG. 5. If the consumer is not a registered user, the consumer can be given a choice to be connected to a consumer service representative (CSR) or allowed to register over the phone or on-line via a series of prompts designed to elicit from the consumer the consumer's name, contact information and other desired identifying information. These registration choices are illustrated by blocks 94, 96, 98 in respect to registration through a CSR, and blocks 94 and 100 in respect to registration via on-line prompts of a web interface, or voice prompts given by an interactive voice response system. The system then proceeds to the post registration inquiry response follow-up activity represented by block 97.

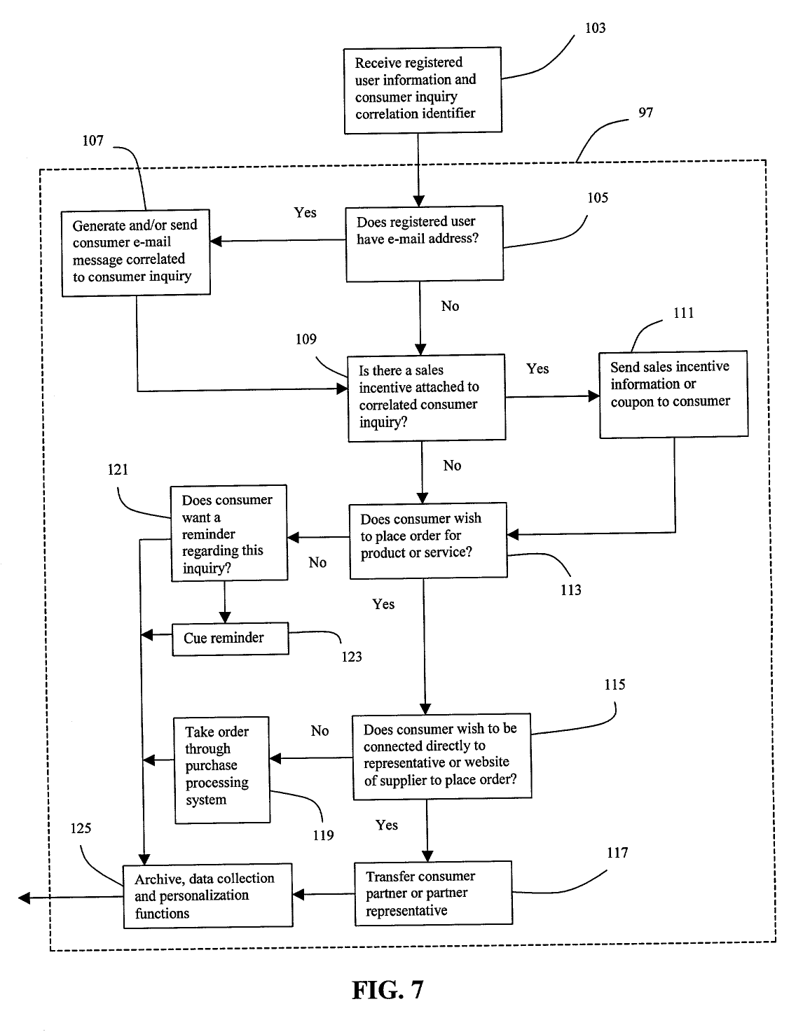

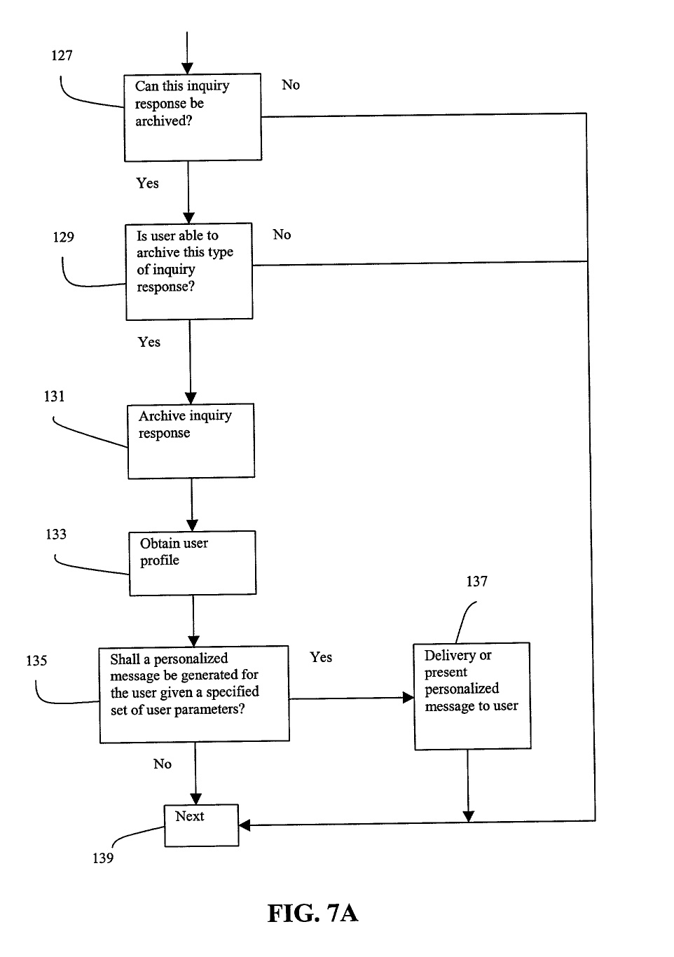

FIG. 7 graphically illustrates the types of post-registration inquiry response follow-up activity that can be performed by the RTIRS. Such activity involves a variety of possible demand stimulus responses sent to the consumer in response to the consumer's inquiry. It is understood that the potential demand stimulus responses in a particular category are not limited to the demand stimulus responses shown in FIG. 7, nor do the demand stimulus responses have to be delivered to the consumer in the order shown. It is also noted that the invention contemplates the possibility of follow-up activity being performed by the RTIRS with unregistered users, such as the possibility of capturing a consumer's phone number through an automatic number identification (ANI) system.

Referring to the flow chart illustrated in FIG. 7, the demand stimulus responses delivered in the inquiry response follow-up are based on registered user information and consumer inquiry correlation identifiers associated with the consumer inquiry which allow the identified consumer inquiry content to be correlated with a demand stimulus response or series of demand stimulus responses (block 103). First, the RTIRS determines whether the registered user who made the inquiry has an e-mail address (block 105) and, if so, generates and/or sends a pre-stored consumer e-mail message to the consumer at the identified e-mail address (block 107). Such an e-mail message may be a confirmation of the information delivered to the consumer by an interactive voice response system, or further information regarding the consumer's inquiry.

After the e-mail message is sent, or if the registered user has no e-mail address, a determination is made whether a special sales incentive is attached to the correlated consumer inquiry (block 109), and if so, sales incentive information or a redeemable coupon is sent to the consumer by a selected route, such as by sending a printable e-mail coupon, or by triggering the mailing of a physical coupon, or by sending an electronic or digital coupon which can be redeemed by a retailer from a wireless communication device such as a WAP telephone (block 111).

The registered user can then be asked whether he or she wishes to place an order for the product or service which is the subject of the inquiry (block 113). If yes, the consumer is given the option to be connected directly to a representative or web site of the supplier to take an order or to a customer service representative of the system operator to assist in ordering (blocks 115, 117); if no, the consumer is optionally permitted to place orders through a purchase processing system where orders are taken directly on-line or via an interactive voice response system by the RTIRS (block 119).

In another aspect to the follow-up activity, the consumer who elects not to place an order for the product or service at the time of the inquiry can elect to receive a reminder concerning the inquiry at a future date (blocks 121, 123).

In a further aspect of the follow-up activity, the RTIRS performs archive, data collection, and personalization functions (block 125) such as more particularly illustrated in FIG. 7A.

FIG. 7A illustrates process steps that can be performed by the RTIRS for archiving inquiry responses on the personal web page of a registered user or on other user devices having storage capabilities, such as PDA'S, cell phones, and other wireless information devices. The flow chart of FIG. 7A also shows process steps for generating and sending a personalized message to the user.

As a first step in the flow chart of FIG. 7A, the RTIRS determines whether the inquiry response made to the user inquiry is a response for which archival will be permitted (block 127). Reasons for preventing the archival of particular responses include possible legal constraints on the copying and distribution of the information and information which has no archival value because of time sensitivity issues. Stored stimulus responses may include stored instructions directing whether archival will be permitted or not.

Assuming the inquiry response is a response capable of being archived, the RTIRS then determines whether the user making the inquiry is able to archive this type of inquiry response (block 129). This will depend on the type of interface used by the consumer to access the RTIRS and whether it is capable of archiving the responses. Archival will only be possible if the consumer has a personalized section of a website as provided by the RTIRS to which the response can be stored, or is connected to a communications device having storage capabilities. If the user is able to archive the inquiry response, the RTIRS will direct that the stimulus response be delivered to the consumer for archiving (block 131).

The RTIRS then obtains the user profile from a user profile database (block 133) and determines whether to generate a personalized message for the user making the inquiry (block 135). The generation of a personalized message is based on a set of parameters retrieved by the RTIRS, such as the user profile, the user's inquiry history, and the stored history of inquiry responses for the user making the inquiry. Such personalized messages could be additional text in an e-mailed message sent to the user which is tailored to the particular user's inquiry history and/or user profile or a banner ad triggered by particular characteristics of the user's inquiry history or profile. If the set of parameters established for generating a personalized message do not exist, no message is sent; if the set of parameters trigger a personalized message the personalized message is delivered to the user (block 137). Upon delivery of the personalized message, the RTIRS proceeds to the next step (block 139), if any, or simply quits as indicated in the flow chart of FIG. 7.

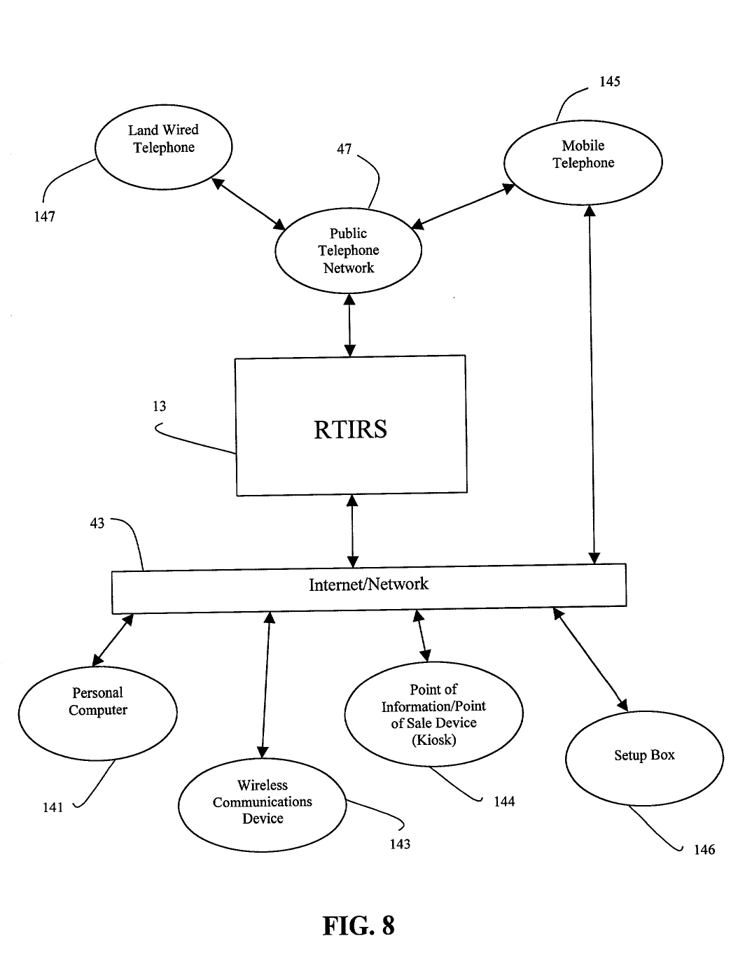

FIG. 8 provides a general conceptual overview of different platforms from which the consumer can interface with the real-time inquiry response system 13 of the invention. It can be seen that the RTIRS can be accessed through the Internet 9 (or other communications network 43) by a personal computer 141, any wireless information device 143, kiosk 144 supplied at consumer accessible locations to serve as a point of information and/or point of sale device, a web-enabled mobile telephone 145, or a set-top box 146 which can be a video game console, cable box or web TV. Access can also be had through the public telephone network 44 by a land wired telephone 147 or by the wireless mobile phone 145 above-mentioned. Thus, it can be seen that the RTIRS can be accessed from a variety of platforms which are web-based, accessible over a network, or based on telephone access over a public telephone network, and which include wireless platforms which make the RTIRS easily accessible at the peak point of interest of the consumer. For example, a consumer having a wireless telephone, upon encountering a demand stimulus, such as a billboard ad, could call an 800 number for accessing the RTIRS, and specifically the interactive voice response system of the RTIRS. The IVR would then take the consumer through a series of interactive voice prompts giving the consumer immediate access to the information he or she needs to make a purchase decision or decision to take some other action.

The following is an illustrative example of a sequence of IVR voice prompts and consumer responses that can be used to step a consumer through the interactive voice response system of RTIRS for distinguishing between a song or ad category of information and for obtaining information about an ad encountered by the consumer for a fictitious airline called “Acme Airlines”:

| | |
|---|---|
| IVR: | “Please say ‘song’ to get more information about a song, say |
| | ‘ad’ to get more information about an ad.” |
| USER: | “Ad.” |
| IVR: | “Please say the key words for the ads for which you would like |
| | additional information.” OR, “Please say some words that |
| | describe the ad you are interested in.” |
| USER: | “Acme Airlines.” |

At this point, the IVR system does a speech-to-text conversion on the words spoken by the user, and then issues a request to the ad category database to perform a search for the ad key words and/or the entire text description for each ad stored in the advertisement category database. The advertisement category database will then return inquiry responses found that match the text parameters, as well as indices for retrieving specific ad information to be delivered to the consumer in any follow-up activity, such as sending the specific e-mail messages or discount coupons to the consumer.

| | |
|---|---|
| IVR: | “We found two ads that match those key words.” |

The IVR then issues a request to the advertisement category database to return the inquiry responses pointed to by the indices returned previously. The IVR then uses text-to-speech conversion to play back ad information to the consumer which comprises the inquiry response.

IVR plays content of both ads (i.e., the inquiry responses for the ads)

| | |
|---|---|
| IVR: | “In order to make it easy for you, we'll send you information and |
| | promotional offers from Acme Airlines in an e-mail,” OR “We |
| | will send you a coupon you can use to redeem this offer at any |
| | Acme Airlines counter.” |

The IVR system then issues a request to a mail server to send out an e-mail containing the coupon to the consumer.

As an alternative, the IVR system may announce that an electronic coupon is being sent to the user's mobile phone for redemption at any Acme Airlines counter which has a data receptacle capable of receiving the coupon.

The IVR system can alternatively or additionally proceed as follows:

| | |
|---|---|
| IVR: | “Please say ‘yes’ if you would like to be transferred to an Acme |
| | Airlines agent right now to take advantage of a special offer.” |
| USER: | “Yes.” |

IVR transfers call to Acme Airlines consumer sales representative or IVR system.

The IVR may further continue as follows:

| | |
|---|---|
| IVR: | “Please say ‘purchase’ to purchase a ticket now.” |
| USER: | “Purchase.” |
| IVR: | “Please say or enter your secret pin code.” |
| USER: | “User says or enters on a key pad his or her secret pin code.” |

The IVR system can then verify that the user's ANI number or log on voice print and the user's secret pin code all match, and, if a match is detected, can issue a request to the ad database to retrieve pricing for the Acme Airlines tickets. The IVR system then can issue a request to a payment processing system to debit the user's credit card or phone bill. After the payment processing system reports a successful debit, the IVR can issue a request to send a receipt to the user and confirm the order has been processed. The receipt can be sent as an encrypted receipt to a wireless information device of the user.

The following is a further illustrative example of a sequence of IVR voice prompts and computer responses that can be used to step a consumer through an interactive voice response system of the RTIRS for distinguishing between a song and an ad category and for obtaining information about a song heard on the radio or TV:

| | |
|---|---|
| IVR: | “Please say ‘song’ to get more information about a song, say |
| | ‘ad’ to get more information about an ad.” |
| USER: | “Song.” |
| IVR: | “Please say the radio station frequency or call letters on which |
| | you heard the song.” |
| USER: | “1050” or “KXOX.” |

The IVR system then plays back to the consumer station ID information corresponding to the station frequency or call letters and continues:

| | |
|---|---|
| IVR: | “If this is not the station you are looking for, please say ‘wrong |
| | station’.” |

If user says “wrong station,” the IVR system takes the user back to the previous prompt. If not, the IVR system continues:

| | |
|---|---|
| IVR: | “Here is what just played.” |

The IVR system plays song clip of last song played, and gives user a voice message stating the song title and artist name, and then continues:

| | |
|---|---|
| IVR: | “Say ‘yes’ if this is the song you are looking for. In order |
| | to make it easy for you, we will send you an e-mail with more |
| | information regarding this song.” |
| USER: | “Yes.” |

If the user says “no,” the IVR can step the user back through previously played songs corresponding to the broadcaster's playlist and/or invite the user to specify the approximate time and date the song was played.

| | |
|---|---|
| IVR: | “Please say ‘purchase’ if you would like to purchase this song |
| | or album right now.” |
| USER: | “Purchase.” |

The IVR system here issues a request to the database to query what format the song or album is available in for purchase, and the database returns a text description of all the formats available. The IVR then uses a text speech conversion to play back a list of available formats to purchase.

The IVR can now provide the following purchase options to the user:

| | |
|---|---|
| IVR: | “Please say ‘download’ to purchase a digital download, |
| | say ‘CD’ to purchase a physical CD.” |
| USER: | “Download.” |
| IVR: | “Please say or enter your secret pin code.” |
| USER: | Says or enters secret pin code. |

The IVR system then processes the order and acknowledges the purchase to the user. If the user says “CD,” the IVR system will issue a request to the database to query prices for the song or album from different retail outlets and a text price list can be returned to the IVR whereupon the IVR can provide a voice playback of the price list to the user via text-to-voice conversion, for example, “This CD is available from ABC Records for $10, and XYZ Records for $12. ” The IVR system can then continue:

| | |
|---|---|
| IVR: | “Say ‘ABC’ to purchase from ABC Records, ‘XYZ’ to purchase |
| | from XYZ Records.” |
| USER: | “ABC.” |
| IVR: | ”Say ‘yes’ to check the availability of this CD from the |
| | closest ABC Records store.” |
| USER: | “Yes.” |

Here the closest ABC Record store can be obtained from further information obtained from the user through a series of suitable voice prompts or, if the user has a mobile phone or other wireless device with a global positioning system (GPS) transceiver, the IVR can retrieve the user's coordinates via the GPS transceiver to determine the location of the closest ABC Record store. The IVR system can then continue:

| | |
|---|---|
| IVR: | “The ABC Record store closest to your current location is |
| | 100 Main Street, they have the CD in stock, say ‘purchase’ |
| | to purchase this CD from this ABC Record store.” |
| USER: | “Purchase.” |

The IVR system can then process the user's order in a manner similar to the examples given above. The IVR could also give the user directions to the nearest ABC Record store.

Each of the foregoing illustrative examples contemplates that the supplier of the goods or services are information providers of the system and supply the content database with the data needed to provide the consumer inquiry responses retrieved by the RTIRS.

Therefore, it can be seen that the present invention provides a system and method for providing on demand responses to consumer impulses produced by a variety of demand stimuli encountered by consumers in a variety of different media, including broadcast media and non-broadcast media. The system and method of the invention also provides on demand responses to consumer impulses produced by internal demand stimuli, that is, demand stimuli which is not encountered from a particular source. Furthermore, the invention also provides a system and method for providing on demand responses to consumer impulses through a variety of different platforms by which the consumer can access information in real time, including access over a public telephone network or the Internet or other communications network. While the invention has been described in considerable detail in the foregoing specification, it will be understood that it is not intended that the invention be limited to such detail except as necessitated by the following claims.

What we claim is:

1. A system for providing on-demand responses to consumer impulses produced by a demand stimulus comprising
a computer processing system, and
a content database accessible by said computer processing system, said content database having stored stimulus responses corresponding to a plurality of consumer demand stimuli in at least two content categories of demand stimuli,
said computer processing system further having a real time inquiry response system for receiving inquiries submitted by a consumer through a consumer interface regarding demand stimuli encountered by the consumer and for identifying the content category with which said consumer inquiry is associated, and
said computer processing system having further means for correlating consumer inquiries received by said real time inquiry response system with stimulus responses stored in said consumer stimulus content database based on the content category identified by said inquiry response system so that said inquiry response system can return to the consumer in real time a stored stimulus response for the consumer inquiry.

2. The system of claim 1 wherein the content categories of demand stimuli include external demand stimuli.

3. The system of claim 2 wherein said external demand stimuli content category includes broadcast demand stimuli and wherein the stored stimulus responses for said broadcast demand stimuli includes further information regarding said broadcast.

4. The system of claim 3 wherein said broadcast demand stimuli includes broadcast music and broadcast advertisements, and wherein the stored stimulus responses for said broadcast music includes further information regarding said music and the stored stimulus responses for said broadcast advertisements includes further information regarding the subject of the advertisements.

5. The system of claim 2 wherein said external demand stimuli content category includes print advertisements and wherein the stored stimulus responses for said print advertisements includes further information regarding the subject of said print advertisements.

6. The system of claim 2 wherein said external demand stimuli content category includes billboard advertisements and wherein the stored stimulus responses for said billboard advertisements includes further information regarding the subject of said billboard advertisements.

7. The system of claim 2 wherein said external demand stimuli content category includes advertisements selected from the group consisting of broadcast advertisements, print advertisements and billboard advertisements.

8. The system of claim 7 wherein said consumer stimulus content database includes pre-defined keys supplied to consumers which can be inputted to the computer processing system through said consumer inquiry interface, and wherein the means for correlating consumer inquiries received from said consumer inquiry interface with stimulus responses stored in said consumer stimulus content database includes an association of said pre-defined keys with stored stimulus responses such that a consumer inquiry which includes a pre-defined key will return a stored stimulus response associated with said key.

9. The system of claim 8 wherein said pre-defined keys are in the form of at least one key word.

10. The system of claim 7 wherein the stored stimulus response returned to the consumer is stored information regarding the subject of the advertisement which stimulated the consumer demand.

11. The system of claim 7 wherein the stored stimulus response returned to the consumer is contact information for the advertiser which allows the consumer to contact the advertiser directly to learn more about an advertised product or service.

12. The system of claim 7 wherein the stored stimulus response returned to the consumer is contact information for the advertiser which allows the consumer to place an order for an advertised product or service.

13. The system of claim 7 wherein the response returned to the consumer is an indicia of a redeemable discount for an advertised product or service.

14. The system of claim 13 wherein the indicia of a redeemable discount is an electronic coupon.

15. The system of claim 2 wherein said categories of demand stimuli further includes internal demand stimuli, wherein said internal demand stimuli includes a consumer desire to attend an event, and wherein the stored stimulus responses to a consumer inquiry stimulated by a desire to attend an event includes information regarding the event.

16. The system of claim 15 wherein said internal demand stimuli includes the consumer desire to attend events selected from the group consisting of movies, concerts, plays, nightclub acts, lectures, and special events, and wherein the stored stimulus responses to a consumer inquiry stimulated by a desire to attend an event includes event information selected from the group consisting of event description, event schedules, and ticket purchase information.

17. The system of claim 16 wherein the stored stimulus response returned to the consumer is contact information for a provider of the event which allows the consumer to contact the event provider directly to learn more about event.

18. The system of claim 16 wherein the stored stimulus response returned to the consumer is contact information for placing an order for tickets to an event.

19. The system of claim 1 wherein the consumer inquiry interface through which the consumer inquiry is made includes a telephone and wherein said real time inquiry response system includes an interactive voice response system which permits consumer inquiries stimulated by a demand stimulus to be made to the inquiry response system for processing by said computer processing system by voice instructions given over the telephone.

20. The system of claim 1 wherein the consumer inquiry interface through which consumer inquiries are made includes a touch tone telephone and wherein said inquiry response system includes means for communicating with a consumer operated touch tone telephone whereby consumer inquiries can be made to the inquiry response system for processing by the computer processing system by a touch tone key pad of the touch tone telephone.

21. The system of claim 1 wherein the consumer inquiry interface through which the consumer inquiry is made includes a data communications device and wherein said inquiry response system includes means for communicating with a consumer operated data communications device.

22. The system of claim 1 wherein the consumer inquiry interface through which the consumer inquiry is made includes a computer apparatus and wherein said inquiry response system includes means for communicating with a consumer operated computer apparatus via a communications network.

23. The system of claim 1 wherein said inquiry response system includes means for communicating with a consumer inquiry interface selected from at least two consumer operated interface devices in the group consisting of a voice telephone wherein consumer inquiries can be made to the inquiry response system by voice instructions, a touch tone telephone whereby consumer inquiries can be made to the consumer response inquiry system by a touch tone key pad of said touch tone telephone, a wireless data communications device wherein consumer inquiries can be made to the consumer response inquiry system by entering data on a touch pad of said wireless data communications device, and a computer connected to a communications network wherein consumer inquiries can be made to the inquiry response system by entering instructions on a keyboard of said computer.

24. The system of claim 1 wherein said inquiry response system includes category selection means which instructs the consumer to select a content category of demand stimuli for which a response is desired, and wherein the means within said computer processing system for correlating consumer inquiries received by said inquiry response system with stimulus responses stored in said consumer stimulus content database is responsive to the content category selected by the consumer.

25. The system of claim 24 wherein each said content category has an associated content name, and wherein the category selection means of said inquiry response system is responsive to the content name supplied to the inquiry response system by the consumer through the consumer inquiry interface.

26. The system of claim 25 where the consumer inquiry interface includes a telephone, wherein said inquiry response system includes an interactive voice recognition system, and wherein said category selection means is responsive to the saying of a category name over the telephone recognized by said interactive voice recognition system.

27. The system of claim 1 wherein said inquiry response system includes means for returning a confirming response to an e-mail address provided by the consumer.

28. A system for providing on-demand responses to consumer impulses produced by a demand stimulus comprising
a computer processing system, and
a content database accessible by said computer processing system, said content database having stored stimulus responses corresponding to a plurality of consumer demand stimuli in at least two content categories of demand stimuli including broadcast music and advertisements selected from the group consisting of broadcast advertisements, print advertisements and billboard advertisements,
said computer processing system further having a real time inquiry response system for receiving inquiries submitted by a consumer through a consumer interface regarding demand stimuli encountered by the consumer and for identifying the content category with which said consumer inquiry is associated, and
said computer processing system having further means for correlating consumer inquiries received by said real time inquiry response system with stimulus responses stored in said consumer stimulus content database based on the content category identified by said inquiry response system so that said inquiry response system can return to the consumer in real time a stored stimulus response for the consumer inquiry.

29. The system of claim 28 wherein said categories of consumer demand stimuli further include a consumer desire to attend events selected from the group consisting of movies, concerts, plays, nightclub acts, lectures, and special events.

30. The system of claim 29 wherein said inquiry response system includes means for communicating with a consumer inquiry interface selected from at least two consumer operated interface devices in the group consisting of a voice telephone wherein consumer inquiries can be made to the inquiry response system by voice instructions, a touch tone telephone whereby consumer inquiries can be made to the consumer response inquiry system by a touch tone key pad of said touch tone telephone, a wireless data communications device wherein consumer inquiries can be made to the consumer response inquiry system by entering data on a touch pad of said wireless data communications device, and a computer connected to a communications network wherein consumer inquiries can be made to the inquiry response system by entering instructions on a keyboard of said computer.

31. A method of providing on-demand responses to consumer impulses produced by a demand stimulus comprising
providing a content database having stored demand stimulus responses corresponding to a plurality of demand stimuli in at least two content categories of demand stimuli,
receiving a consumer inquiry stimulated by demand stimulus and directing the inquiring consumer to identify the category to which the demand stimuli producing the inquiry pertains,
correlating the received demand inquiry with a stimulus response stored in said content database based on the content category identifying by the consumer, and
returning to the consumer the stored stimulus response corresponding to the consumer's inquiry.

32. The method of claim 31 wherein the categories of demand stimuli are first identified by whether the source of the demand stimuli can be identified.

33. The method of claim 32 wherein, if a source can be identified, the categories of demand stimuli are further identified by whether the demand stimuli is broadcast demand stimuli or non-broadcast demand stimuli.

34. The method of claim 31 wherein the categories of demand stimuli are first identified by whether the demand stimuli are broadcast demand stimuli or non-broadcast demand stimuli.

35. The method of claim 31 wherein said content categories of demand stimuli include broadcast demand stimuli and wherein the stored stimulus responses returned to the consumer in response to a consumer inquiry relating to broadcast demand stimuli include further information relating to said broadcast.

36. The method of claim 35 wherein
said broadcast demand stimuli includes broadcast music and broadcast advertisements,
the inquiring consumer is directed to identify whether the demand stimulus that produced the inquiry pertains to broadcast music or a broadcast advertisement and then to provide identifying information regarding broadcaster of the music or advertisement, and
at least one stored stimulus response is returned correlated to the broadcaster identified by the consumer and the date and time the consumer inquiry is made.

37. The method of claim 36 wherein the returned stored stimulus response includes at least one response selected from a group consisting of audio clips of the broadcast, text clips of the broadcast, and video clips of the broadcast.

38. The method of claim 37 wherein the returned stored stimulus response includes indicia of a redeemable discount for the music or advertisement broadcast by the identified broadcaster.

39. The method of claim 38 wherein the indicia of a redeemable discount is an electronic coupon.

40. The method of claim 31 wherein said content categories of demand stimuli include demand stimuli in the form of advertisements for products and services and wherein the stored stimulus responses returned to the consumer in response to a consumer inquiry relating to an advertisement for products and services include further information relating to the advertised product or service to which the inquiry pertains.

41. The method of claim 40 wherein the returned stored stimulus responses include indicia of a redeemable discount for the music or advertisement broadcast by the identified broadcaster.

42. The method of claim 41 wherein the indicia of a redeemable discount is an electronic coupon.

43. The method of claim 40 wherein the returned stored stimulus responses include a confirming e-mail message relating to the product or service to an e-mail box for the consumer.

44. The method of claim 40 further comprising determining the location of the consumer and returning a stored stimulus response to the consumer which gives the consumer directions to a retail outlet for the product or service.

45. The method of claim 40 wherein the returned stored stimulus responses include connecting the consumer directly to a representative of the advertiser of the product or service.

46. The method of claim 40 wherein the consumer is directed to supply at least one key word pertaining to the advertisement producing the consumer inquiry and wherein the key word supplied by the consumer is used to correlate the advertisement producing the consumer inquiry to a stored stimulus response.

47. The method of claim 46 wherein the at least one key word is placed in the advertisement of the product or service for use by the consumer in making a consumer inquiry.

48. The method of claim 31 wherein the consumer is directed to supply at least one key word pertaining to the demand stimulus producing the consumer inquiry and wherein the key word supplied by the consumer is used to correlate the demand stimulus producing the consumer inquiry to a stored stimulus response.
